(19) United States
(12) Patent Application Publication
(10) Pub. No.: US 2015/0123495 A1
(43) Pub. Date: May 7, 2015

(54) RESET UNIT AND PORTABLE ELECTRONIC DEVICE HAVING SAME

(71) Applicant: MERRY ELECTRONICS (SUZHOU) CO., LTD., Suzhou City (CN)

(72) Inventor: Ming-Hung TSAI, Taichung City (TW)

(73) Assignee: MERRY ELECTRONICS (SUZHOU) CO., LTD., Suzhou City (CN)

(21) Appl. No.: 14/161,080

(22) Filed: Jan. 22, 2014

(30) Foreign Application Priority Data
Nov. 6, 2013 (TW) 102140322

(51) Int. Cl. H02J 1/00; H02J 7/00

(52) U.S. Cl. CPC H02J 1/00; H02J 7/0063
USPC 307/130

(57) ABSTRACT

A portable electronic device is formed of a system circuit, a battery, a normally open switch, and a reset unit. The system circuit includes a processor. The normally open switch is electrically connected with the battery. The reset unit is electrically connected with the system circuit, the battery, and the normally open switch and includes a reset switch and a control circuit. The control circuit is electrically connected with the reset switch. When the normally open switch is continuously conducted, electric energy accumulated in the control circuit reaches a predetermined threshold potential to cut of the reset switch to further stop the battery from supplying electric energy for the system circuit.

### BACKGROUND OF THE INVENTION

1. Field of the Invention The present invention relates generally to a general electronic device and more particularly, to a reset unit and a portable electronic device having the reset unit.

2. Description of the Related Art

When the system of a conventional portable electronic device (such as smart mobile phone, notebook computer, or tablet computer) crashes, a user usually needs to detach a built-in battery from the portable electronic device for the time being to forcibly reset the portable electronic device.

However, as the portable electronic device gradually becomes lighter and thinner in structural design, so the built-in battery of the portable electronic device has gradually became undetachable. When the system crashes, the user usually needs to wait for exhaustion of the battery and then recharge and restart the system to make the portable electronic device function normally. In this way, the user has to waste time before the battery becomes dead, so it is very inconvenient in operation.

To solve the aforesaid problem and to forcibly reset the system of the portable electronic device, U.S. Patent Laid-open No. 2012293220 disclosed a reset control unit, in which a signal generating unit can generate and send a control signal in conformity with a predefined rule to a control module and then the control module deactivates a switch according to the control signal and reactivates the switch after the switch is turned off for a predetermined duration. It indicates that the control module needs to do complicated active computation, so the reset control device has complicated design to increase the cost.

### SUMMARY OF THE INVENTION

The primary objective of the present invention is to provide a portable electronic device which can be reset without detachment of its battery or waiting for exhaustion of its battery. The foregoing objective of the present invention is attained by the portable electronic device formed of a system circuit, a battery, a normally open switch, and a reset unit. The system circuit includes a processor. The normally open switch is electrically connected with the battery. The reset unit is electrically connected with the system circuit, the battery, and the normally open switch and includes a reset switch and a control circuit. The control circuit is electrically connected with the reset switch.

When the normally open switch is continuously conducted, electric energy accumulated in the control circuit reaches a predetermined threshold potential to cut off the reset switch to further stop the battery from supplying electricity for the system circuit.

The secondary objective of the present invention is to provide a reset unit which is structurally simple to be low-cost.

The foregoing objective of the present invention is attained by the reset unit electrically connected with a system circuit, a battery, and a normally open switch of a portable electronic device. The reset unit includes a reset switch and a control circuit electrically connected with the reset switch. When the normally open switch is continuously conducted, electric energy accumulated in the control circuit reaches the predetermined threshold potential to cut of the reset switch to further stop the battery from supplying electricity for the system circuit.

In light of the above, the portable electronic device of the present invention can reset by continuously pushing the normally open switch to make the reset unit cut off the path of power supply from the battery to the system circuit.

Preferably, the control circuit further includes an energy storage unit and an energy release unit. The energy storage unit can receive and store the electric energy of the battery. The threshold potential is the voltage potential that the energy storage unit stores the electrical energy. The energy release unit is electrically connected with the energy storage unit for the energy storage unit to release the electric energy. In this way, the portable electronic device of the present invention can avoid any false action resulting from continuously and quickly pushing the normally open switch.

### BRIEF DESCRIPTION OF THE DRAWINGS

FIG. 1 is a block diagram of a preferred embodiment of the present invention.

FIG. 2 is a circuit diagram of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

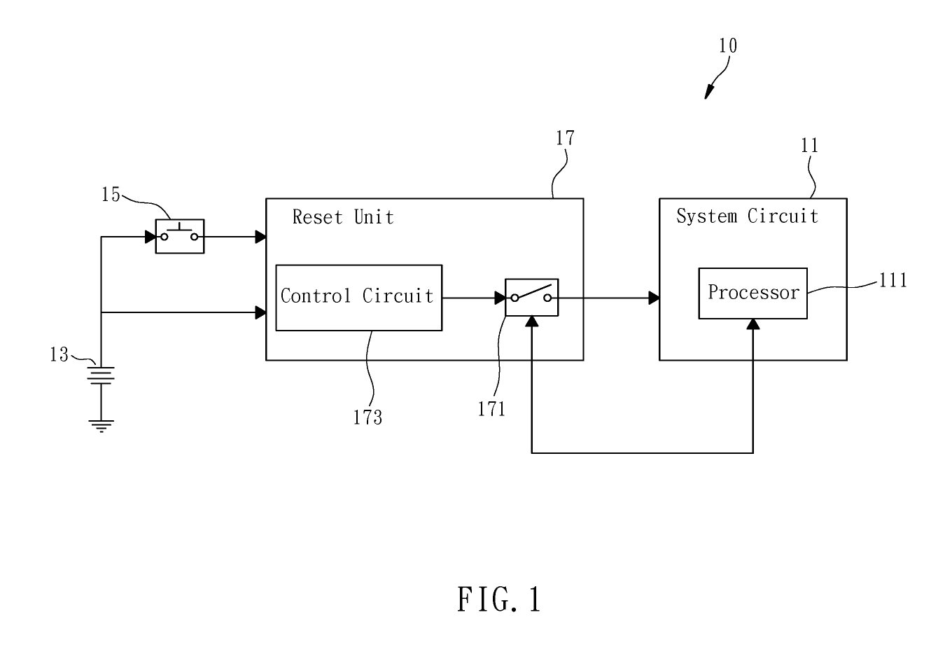

Referring to FIG. 1, a portable electronic device 10 of the present invention can be a smart phone, a notebook computer, a tablet computer, a Motion Picture Experts Group Audio Layer III (MP3) player, a Bluetooth earphone, or an electronic sphygmomanometer, either of which is installed with undetachable battery. In this preferred embodiment, the portable electronic device 10 is a Bluetooth earphone as an example and formed of a system circuit 11, a battery 13, a normally open switch 15, and a reset unit 17. The detailed descriptions and operations of these elements as well as their interrelations are recited in the respective paragraphs as follows.

The system circuit 11 is the primary circuit of the Bluetooth earphone and includes a processor 111 that is a central processing unit (CPU), a microcontroller unit (MCU), or a system on a chip. The battery 13 is to supply electricity for the Bluetooth earphone. The normally open switch 15 is electrically connected with the battery 13 and remains open-circuit normally. The normally open switch 15 becomes closed-circuit, while the normally open switch 15 is pushed by an external force or triggered by a particular signal. When the external force or the particular signal is no longer available, the normally open switch 15 becomes open-circuit again. The normally open switch 15 is usually the power switch of the Bluetooth earphone.

The reset unit 17 is electrically connected with the system circuit 11, the battery 13, and the normally open switch 15 and includes a reset switch 171 and a control circuit 173. The control circuit 173 is electrically connected with the reset switch 171. When the normally open switch 15 is continuously conducted to make the electric energy accumulated in the control circuit 173 reach a predetermined threshold potential, the reset switch 171 is cut off to stop the battery 13 from supplying the system circuit 11 with electric energy. In this way, the portable electronic device 10 can cut off the path of power supply from the battery 13 to the system circuit 11.

When it is intended to activate the portable electronic device 10, the user can push the normally open switch 15 for a short time to make the normally open switch conducted for a short time to further enable the battery 13 to supply the electric energy for the system circuit 11, so the booting procedure is completed. When the booting procedure is completed, the control circuit 173 stops working, indicating that the control circuit 173 is not accumulated with electric energy of the battery 13; meanwhile, the electric energy accumulated in the control circuit 173 does not reach the predetermined threshold potential, so the processor 111 can keep the reset switch 171 continuously conducted to enable the electric energy of the battery 13 to be continuously supplied for the system circuit 11.

When the portable electronic device 10 completes the booting procedure, under the normal circumstances, if the user carelessly pushes the normally open switch 15 for a short time, indicating that the accumulated electric energy of the control circuit 173 has not reached the predetermined threshold potential, the reset switch 171 will still keep conducted to enable the battery 13 to continuously supply the system circuit 11 with the electric energy.

It is to be particularly noted that when it is found that the system crashes after the portable electronic device 10 completes the booting procedure, indicating that the portable electronic device 10 cannot be normally operated, the user can keep pushing the normally open switch 15 continuously to make the accumulated electric energy of the control circuit 173 reach the predetermined threshold potential. In the meantime, the reset switch 171 is cut off to make the path between the battery 13 and the system circuit 11 open-circuit to no longer supply the electric energy for the system circuit 11 to further reset the portable electronic device 10. If the portable electronic device 10 needs to be restarted, the user only needs to push the normally switch 15 for short time.

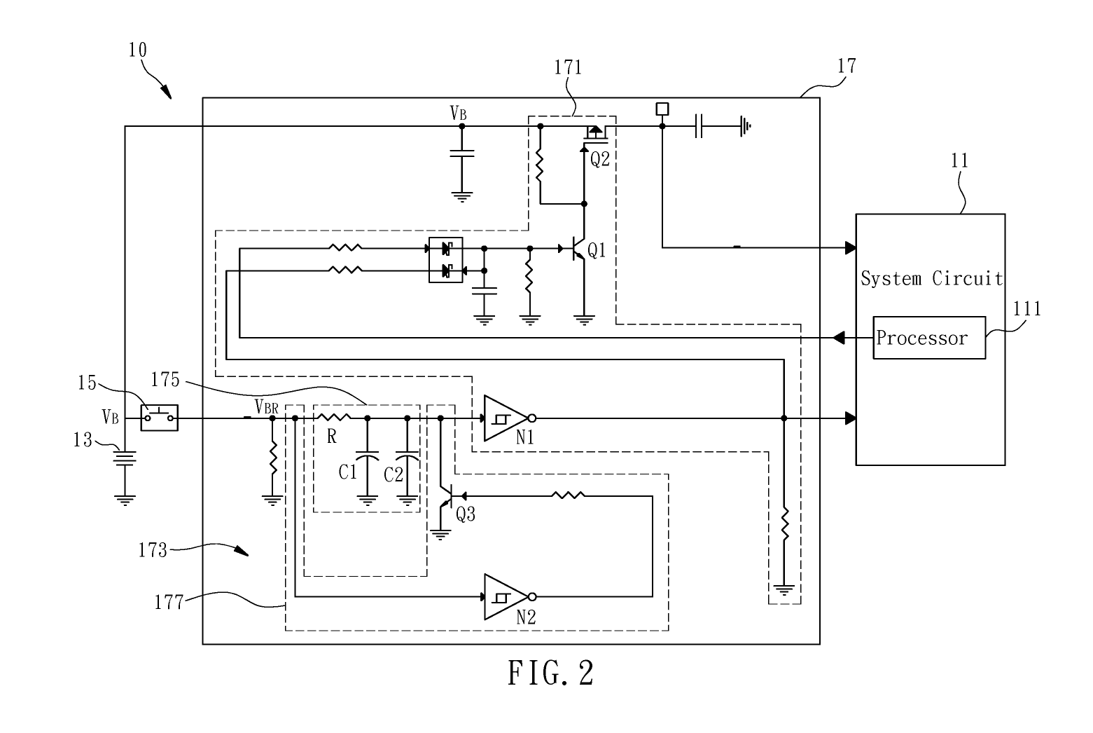

FIG. 2 illustrates a circuit diagram of the portable electronic device 10 and only shows one of circuits of the portable electronic device 10, not limiting the circuitry of the portable electronic device 10, so the circuitry of the portable electronic device 10 of the present invention is not limited to FIG. 2.

The control circuit 173 includes an energy storage unit 175. In this preferred embodiment, the energy storage unit 175 is formed of a resistor R and two capacitors C1 and C2, both of which are connected in parallel, for receiving and storing the electric energy of the battery 13. In this way, the control circuit 173 can accumulate the electric energy via the two capacitors C1 and C2.

In addition, the predetermined threshold potential is the voltage potential of the two capacitors C1 and C2, indicating that the predetermined threshold potential is variable subject to the two capacitors C1 and C2 and the resistor R, so the predetermined threshold potential is adjustable as per actual requirement. In other words, the capacitors C1 and C2 of the energy storage unit 175 are variable in number and at least one capacitor and at least one resistor are required.

Referring to FIG. 2 again, the control circuit 173 further includes an energy release unit 177. The energy release unit 177 is electrically connected with the energy storage unit 175 for the energy storage unit 175 to release the electric energy. In this way, the electric energy of the energy storage unit 175 can be released by the energy release unit 177 to prevent the portable electronic device 10 from any false action. In particular, when the normally open switch 15 is pushed for a short time continuously, the electric energy accumulated in the energy storage unit 175 can be released through the energy release unit 177 to prevent the energy storage unit 175 from accumulating the electric energy continuously and reaching the predetermined threshold potential, so the portable electronic device 10 of the present invention has preferable stability.

It is to be particularly noted that the energy storage unit 175 and the energy release 177 are though not shown in FIG. 1 but in practice, they are included in the control circuit 173. In this preferred embodiment, the reset switch 171 is formed of two transistors Q1 and Q2 as an example. The reset switch 171 can be formed of diodes or other electronic components, so the reset switch 171 is not limited to the one illustrated in FIG. 2. The energy release unit 177 is formed of the transistor Q3 and the NOT gate N2 as an example, and can make by other electronic components to release the electric energy from the energy storage unit 175. That means the energy release unit 177 is not limited to the one illustrated in FIG. 2.

In view of FIG. 1 again, the portable electronic device 10 shown in FIG. 2 can be restarted by pushing the normally open switch 15 for a short time to enable the battery 13 to supply voltage V_{BR} for the energy storage unit 175 via the conducted normally open switch 15. However, the energy storage unit 175 does not store the electric energy into the threshold potential, so a NOT gate N1 of the reset switch 171 can receive a low-potential signal and output a high-potential signal corresponding to the low-potential signal. The high-potential signal can trigger the processor 111. Next, the processor 111 can controllably make the transistors Q1 and Q2 conducted to enable the battery 13 to supply voltage V_{B} for the system circuit 11.

Under the normal circumstances after the portable electronic device 10 is restarted, when the user push the normally open switch 15 for a short time again, the energy storage unit 175 can receive the voltage V_{BR} from the battery 13 again and charge the capacitors C1 and C2. However, the normally open switch 15 is pushed for insufficient time to disable the energy storage unit 175 from storing the electric energy into the threshold potential, so the NOT gate N1 can still output the high-potential signal to enable the processor 111 to controllably make the transistors Q1 and Q2 conducted to further enable the battery 13 to continue to supply the voltage V_{B} for the system circuit 11, In particular, the energy storage unit 175 though cannot store the electric energy into the threshold potential under the aforesaid two circumstances, but the energy release unit 177 can release the electric energy from the energy storage unit 175. When the voltage V_{BR} charges the energy storage unit 175, a NOT gate N2 of the energy release unit 177 cuts off a transistor Q3 controllably. When the voltage V_{BR} stops charging the energy storage unit 175, the NOT gate N2 of the energy release unit 177 triggers conduction of the transistor Q3 to allow the electric energy of the energy storage 175 to be released via the transistor Q3.

When the system crashes, the user can push the normally open switch 15 continuously to make the energy storage unit 175 accumulate the voltage V_{BR} up to the threshold potential; meanwhile, the NOT gate N1 receives the high-potential signal, indicating that the NOT gate N1 can output the low-potential signal to the transistors Q1 and Q2 to cut off the transistors Q1 and Q2, so the battery 13 no longer supplies the voltage V_{B} for the system circuit 11 to further thus reset the portable electronic device 10. After the portable electronic device 10 is reset, the energy storage unit 175 can still release the electric energy via the energy release unit 177. Since how the electric energy is released is identical to what is mentioned above, more recitation is skipped.

To sum up, the reset unit of the portable electronic device of the present invention can forcibly cut off the path of the power supply of the battery and the portable electronic device does not need any additional push button (normally open switch) to make the circuitry of the reset unit simple. Furthermore, after the portable electronic device 10 is reset, the energy storage unit 175 can still release the electric energy via the energy release unit 177. Since how the energy storage unit 175 releases the electric energy is identical to what is mentioned above, more recitation is skipped.

In addition, the portable electronic device of the present invention is though installed with the undetachable battery in the aforesaid preferred embodiment as an example for illustration but in fact, the portable electronic device can also be installed with the detachable battery, so in this way, the trouble of detaching the battery can be spared. Thus, the reset unit of the portable electronic device of the present invention is not limited to that of the aforesaid preferred embodiment.

What is claimed is:

1. A portable electronic device comprising:
a system circuit;
a battery;
a normally open switch electrically connected with the battery; and
a reset unit electrically connected with the system circuit, the battery, and the normally open switch, the reset unit having a reset switch and a control circuit, the control circuit being electrically connected with the reset switch; when the normally open switch is conducted continuously to make electric energy accumulated in the control circuit from the battery reach a threshold potential, the reset switch is cut off to stop the battery from supplying the electric energy for the system circuit.

2. The portable electronic device as defined in claim 1, wherein the control circuit comprises an energy storage unit for receiving and storing the electric energy of the battery; the threshold potential is voltage potential of the energy storage unit for storage of the electric energy.

3. The portable electronic device as defined in claim 2, wherein the energy storage unit comprises at least one capacitor and at least one resistor.

4. The portable electronic device as defined in claim 2 wherein the control circuit further comprises an energy release unit electrically connected with the energy storage unit for the energy storage to release the electric energy.

5. The portable electronic device as defined in claim 1, wherein when the normally open switch is conducted and the electric energy accumulated in the control circuit from the battery does not reach the threshold potential, the reset switch is conducted to enable the battery to supply the electric energy for the system circuit.

6. The portable electronic device as defined in claim 5, wherein the system circuit comprises a processor for controllably making the reset switch conducted when the control circuit does not reach the threshold potential.

7. A reset unit for a portable electronic device, the portable electronic device further comprising a system circuit, a battery, and a normally open switch, the normally open switch being electrically connected with the battery, the reset unit being electrically connected with the system circuit, the battery, and the normally open switch, the reset unit further comprising:
a reset switch; and
a control circuit electrically connected with the reset switch;
wherein when the normally open switch is conducted continuously to make electric energy accumulated in the control circuit from the battery reach a threshold potential, the reset switch is cut off to stop the battery from supplying the electric energy for the system circuit.

8. The rest unit as defined in claim 7, wherein the control circuit comprises an energy storage unit for receiving and storing the electric energy of the battery; the threshold potential is voltage potential of the energy storage unit for storage of the electric energy.

9. The rest unit as defined in claim 8, wherein the energy storage unit comprises at least one capacitor and at least one resistor.

10. The rest unit as defined in claim 8, wherein the control circuit further comprises an energy release unit electrically connected with the energy storage unit for the energy storage to release the electric energy.

11. The rest unit as defined in claim 7, wherein when the normally open switch is conducted and the electric energy accumulated in the control circuit from the battery does not reach the threshold potential, the reset switch is conducted to enable the battery to supply the electric energy for the system circuit.
